(19) United States
(12) Patent Application Publication
(10) Pub. No.: US 2026/0106649 A1
(43) Pub. Date: Apr. 16, 2026

(54) SINGLE DOWNLINK CONTROL INFORMATION FOR SCHEDULING MULTIPLE USER EQUIPMENTS FOR MULTIPLE-USER MULTIPLE-INPUT-MULTIPLE-OUTPUT

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/331,919

(22) Filed: Sep. 17, 2025

Related U.S. Application Data
(60) Provisional application No. 63/707,573, filed on Oct. 15, 2024.

(51) Int. Cl. H04B 7/0452; H04W 72/23

(52) U.S. Cl. CPC H04B 7/0452; H04W 72/23

(57) ABSTRACT

Various aspects of the present disclosure generally relate to wireless communication. In some aspects, a network node may transmit one or more configuration messages that indicate one or more parameters that are associated with a single downlink control information (DCI) for scheduling multiple user equipments (UEs) for multiple-user multiple-input-multiple-output (MU-MIMO). The network node may transmit the single DCI, the single DCI being configured to schedule, as the multiple UEs, a first UE and at least a second UE for the MU-MIMO, the single DCI being based at least in part on the one or more parameters. Numerous other aspects are described.

### PRIORITY INFORMATION

The present application for patent claims priority under 35 U.S.C. § 119 to U.S. Provisional Patent Application No. 63/707,573, filed on Oct. 15, 2024, entitled “SINGLE DOWNLINK CONTROL INFORMATION FOR SCHEDULING MULTIPLE USER EQUIPMENTS FOR MULTIPLE-USER MULTIPLE-INPUT-MULTIPLE-OUTPUT,” which is assigned to the assignee hereof and hereby expressly incorporated by reference herein.

### FIELD OF THE DISCLOSURE

Aspects of the present disclosure generally relate to wireless communication and specifically relate to techniques, apparatuses, and methods associated with single downlink control information for scheduling multiple user equipments for multiple-user multiple-input-multiple-output.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A and 3B are diagrams illustrating a first example of multiple-input-multiple-output (MIMO) and a second example of multiple user MIMO, respectively, in accordance with the present disclosure.

FIG. 4 is a diagram illustrating an example of downlink control information that schedules one or more communications with a user equipment (UE), in accordance with the present disclosure.

FIG. 5 is a diagram illustrating an example of a wireless communication process between a network node, a first UE, and a second UE, in accordance with the present disclosure.

FIG. 6 is a diagram illustrating an example process performed, for example, at a network node or an apparatus of a network node, in accordance with the present disclosure.

FIG. 7 is a diagram illustrating an example process performed, for example, at a UE or an apparatus of a UE, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### SUMMARY

Some aspects described herein relate to a method of wireless communication performed by a network node. The method may include transmitting one or more configuration messages that indicate one or more parameters that are associated with a single downlink control information (DCI) for scheduling multiple user equipments (UEs) for multiple-user multiple-input-multiple-output (MU-MIMO). The method may include transmitting the single DCI, the single DCI being configured to schedule, as the multiple UEs, a first UE and at least a second UE for the MU-MIMO, the single DCI being based at least in part on the one or more parameters.

Some aspects described herein relate to a method of wireless communication performed by a first UE. The method may include receiving one or more configuration messages that indicate one or more parameters that are associated with a single DCI for scheduling multiple UEs for MU-MIMO. The method may include receiving the single DCI, the single DCI being configured to schedule, as the multiple UEs, the first UE and at least a second UE for the MU-MIMO, the single DCI being based at least in part on the one or more parameters.

Some aspects described herein relate to an apparatus for wireless communication at a network node. The apparatus may include one or more memories and one or more processors coupled to the one or more memories. The one or more processors may be configured to transmit one or more configuration messages that indicate one or more parameters that are associated with a single DCI for scheduling multiple UEs for MU-MIMO. The one or more processors may be configured to transmit the single DCI, the single DCI being configured to schedule, as the multiple UEs, a first UE and at least a second UE for the MU-MIMO, the single DCI being based at least in part on the one or more parameters.

Some aspects described herein relate to an apparatus for wireless communication at a first UE. The apparatus may include one or more memories and one or more processors coupled to the one or more memories. The one or more processors may be configured to receive one or more configuration messages that indicate one or more parameters that are associated with a single DCI for scheduling multiple UEs for MU-MIMO. The one or more processors may be configured to receive the single DCI, the single DCI being configured to schedule, as the multiple UEs, the first UE and at least a second UE for the MU-MIMO, the single DCI being based at least in part on the one or more parameters.

Some aspects described herein relate to a non-transitory computer-readable medium that stores a set of instructions for wireless communication by a network node. The set of instructions, when executed by one or more processors of the network node, may cause the network node to transmit one or more configuration messages that indicate one or more parameters that are associated with a single DCI for scheduling multiple UEs for MU-MIMO. The set of instructions, when executed by one or more processors of the network node, may cause the network node to transmit the single DCI, the single DCI being configured to schedule, as the multiple UEs, a first UE and at least a second UE for the MU-MIMO, the single DCI being based at least in part on the one or more parameters.

Some aspects described herein relate to a non-transitory computer-readable medium that stores a set of instructions for wireless communication by a first UE. The set of instructions, when executed by one or more processors of the UE, may cause the UE to receive one or more configuration messages that indicate one or more parameters that are associated with a single DCI for scheduling multiple UEs for MU-MIMO. The set of instructions, when executed by one or more processors of the UE, may cause the UE to receive the single DCI, the single DCI being configured to schedule, as the multiple UEs, the first UE and at least a second UE for the MU-MIMO, the single DCI being based at least in part on the one or more parameters.

Some aspects described herein relate to an apparatus for wireless communication. The apparatus may include means for transmitting one or more configuration messages that indicate one or more parameters that are associated with a single DCI for scheduling multiple UEs for MU-MIMO. The apparatus may include means for transmitting the single DCI, the single DCI being configured to schedule, as the multiple UEs, a first UE and at least a second UE for the MU-MIMO, the single DCI being based at least in part on the one or more parameters.

Some aspects described herein relate to an apparatus for wireless communication. The apparatus may include means for receiving one or more configuration messages that indicate one or more parameters that are associated with a single DCI for scheduling multiple UEs for multiple-user multiple-input-multiple-output (MU-MIMO). The apparatus may include means for receiving the single DCI, the single DCI being configured to schedule, as the multiple UEs, the first UE and at least a second UE for the MU-MIMO, the single DCI being based at least in part on the one or more parameters.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In MU-MIMO, a transmitter device may simultaneously serve multiple receiver devices, and/or multiple transmitter devices may serve a single receiver device. As one example, a network node may simultaneously serve multiple user equipments (UEs) using MU-MIMO communications that are based at least in part on beamforming, spatial diversity, and/or polarization diversity.

A network node may configure the UEs for MU-MIMO based at least in part on transmitting respective downlink control information (DCI) to each UE, and the respective DCI may indicate any combination of transmission information, such as a transmission format, a modulation and coding scheme (MCS), a resource allocation, and/or other types of information used by a transmitter to encode, and/or a receiver to decode, transmitted data. Typically, the network node transmits DCI in a physical downlink control channel (PDCCH) that is based at least in part on a control resource set (CORESET), a search space, and one or more control channel element (CCE) candidates within the CORESET. A network node may adjust a number of CCEs and/or a number of CCE candidates that are allocated to a PDCCH, which may alternatively be referred to as a PDCCH aggregation level or simply an aggregation level to accommodate for changing channel conditions. Based at least in part on the CORESET residing in a specific portion of a time-frequency resource grid, and balancing control signaling with data throughput, the number of CCEs may be minimal, reduced, and/or governed by the available resources.

PDCCH MU-MIMO enables a network node to transmit control information via the PDCCH to multiple UEs simultaneously using spatial multiplexing and sharing the air interface resources assigned to the PDCCH. For instance, for each UE scheduled for MU-MIMO communications, the network node may transmit UE-specific control information in the PDCCH using a respective beam that is directed to the respective UE. Although PDCCH MU-MIMO may be used by a network node to increase a capacity of the PDCCH and/or increase a number of UEs that may be scheduled via the PDCCH, the minimal number of CCEs may result in a PDCCH block issue (e.g., CCEs are unavailable to the network node) during particular operating conditions, such as a high traffic volume operating condition and/or a peak traffic volume operating condition. PDCCH blocking may result in increased transmission delays (e.g., delayed scheduling and/or delayed data transfers) and/or reduced system throughput (e.g., reduced data throughput). PDCCH MU-MIMO may increase the transmission delays and/or may reduce system throughput more because PDCCH block issues may apply to multiple UEs, rather than a single UE.

Various aspects relate generally to single DCI for scheduling multiple UEs for MU-MIMO. Some aspects more specifically relate to the use of a single DCI, rather than respective DCIs, for the multiple UEs to reduce CCE usage in a PDCCH. In some aspects, a network node may transmit one or more configuration messages that indicate one or more parameters that are associated with a single DCI for scheduling multiple UEs with MU-MIMO. For instance, as described below, the network node may transmit the configuration message(s) via radio resource control (RRC) signaling, and the configuration messages may indicate one or more configuration parameters associated with a group common (GC)-PDCCH that enables the network node to transmit DCI to a group of devices simultaneously. Based at least in part on transmitting the configuration message(s), the network node may transmit the single DCI. In some aspects, the single DCI may be configured to schedule a first UE and at least a second UE for MU-MIMO communications. The single DCI may be based at least in part on the one or more parameters indicated via the configuration messages.

In some aspects, a first UE may receive one or more configuration messages that indicate one or more parameters that are associated with a single DCI that schedules multiple UEs with MU-MIMO. Based at least in part on receiving the one or more configuration messages, the first UE may receive the single DCI (e.g., using the one or more parameters), and the single DCI may be configured to schedule the first UE and at least a second UE with the MU-MIMO.

Particular aspects of the subject matter described in this disclosure can be implemented to realize one or more of the following potential advantages. In some examples, by using a single DCI to schedule multiple UEs with MU-MIMO, the described techniques can be used to enable a network node to reduce a number of CCEs that are used to transmit DCI that schedules the multiple UEs with MU-MIMO. Reducing the number of CCEs used by the network node to schedule MU-MIMO may lead to the MU-MIMO scheduling process being less susceptible to PDCCH blocking, resulting in reduced transmission delays and/or increased system throughput.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

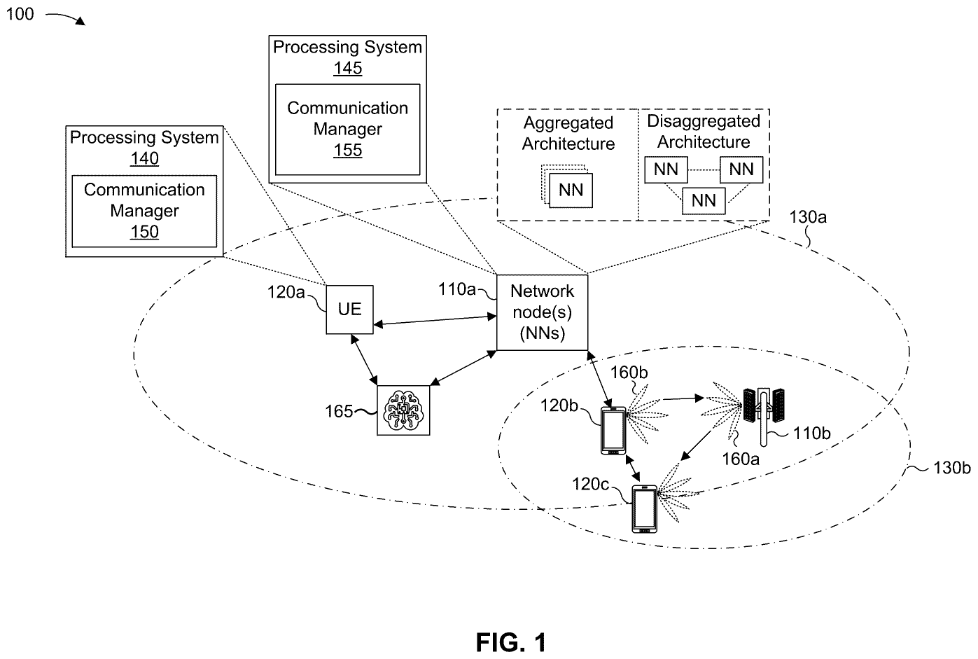

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

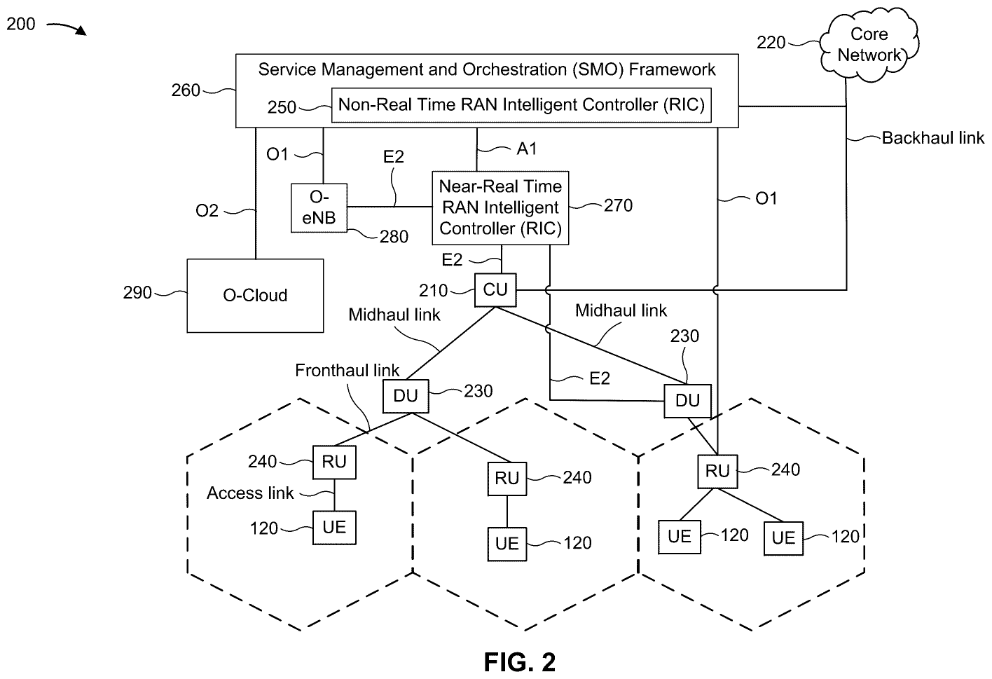

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (LI)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a network node (e.g., a network node 110) may include a communication manager 155. As described in more detail elsewhere herein, the communication manager 155 may transmit one or more configuration messages that indicate one or more parameters that are associated with a single DCI for scheduling multiple UEs for MU-MIMO; and transmit the single DCI, the single DCI being configured to schedule, as the multiple UEs, a first UE and at least a second UE for the MU-MIMO, the single DCI being based at least in part on the one or more parameters. Additionally, or alternatively, the communication manager 155 may perform one or more other operations described herein.

In some aspects, a UE (e.g., a UE 120) may include a communication manager 150. As described in more detail elsewhere herein, the communication manager 150 may receive one or more configuration messages that indicate one or more parameters that are associated with a single DCI for scheduling multiple UEs for MU-MIMO; and receive the single DCI, the single DCI being configured to schedule, as the multiple UEs, the first UE and at least a second UE for the MU-MIMO, the single DCI being based at least in part on the one or more parameters. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-NB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

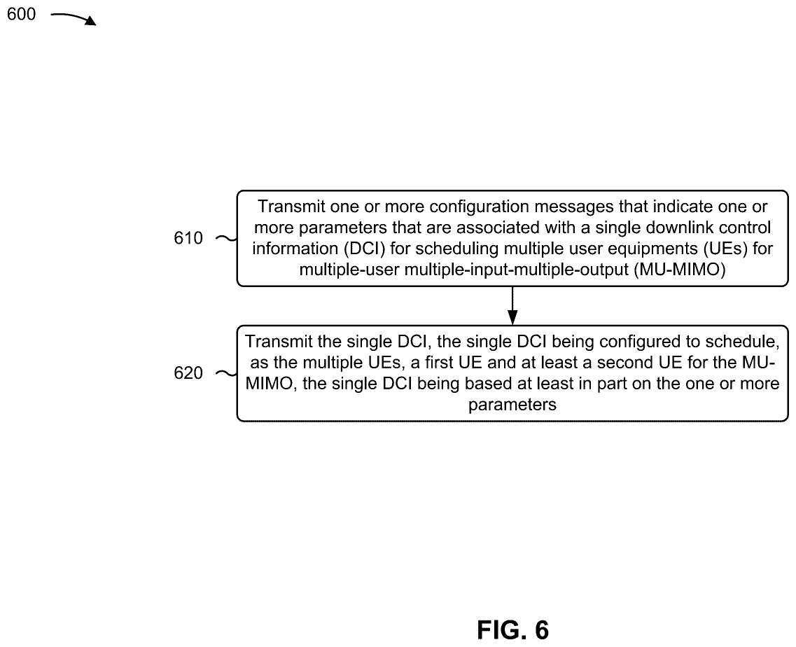

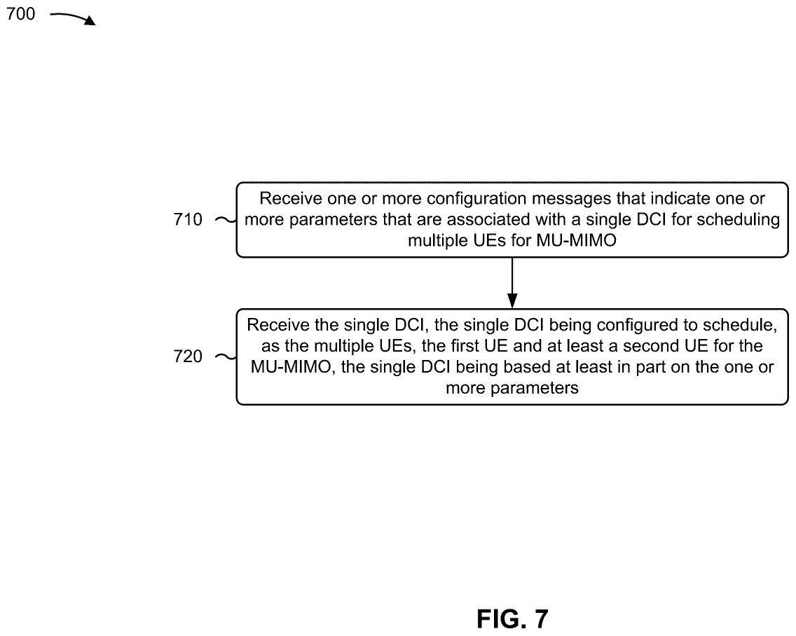

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with single DCI for scheduling multiple UEs for MU-MIMO, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

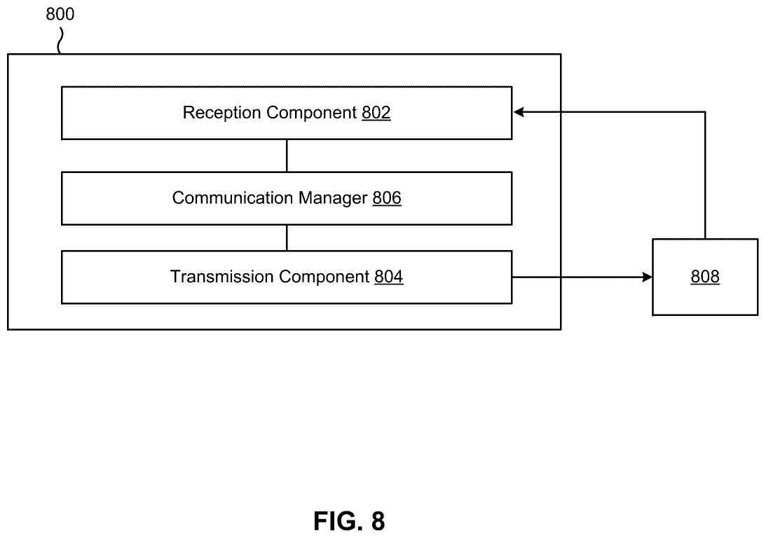

In some aspects, a network node (e.g., a network node 110) includes means for transmitting one or more configuration messages that indicate one or more parameters that are associated with a single DCI for scheduling multiple UEs for MU-MIMO; and/or means for transmitting the single DCI, the single DCI being configured to schedule, as the multiple UEs, a first UE and at least a second UE for the MU-MIMO, the single DCI being based at least in part on the one or more parameters. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

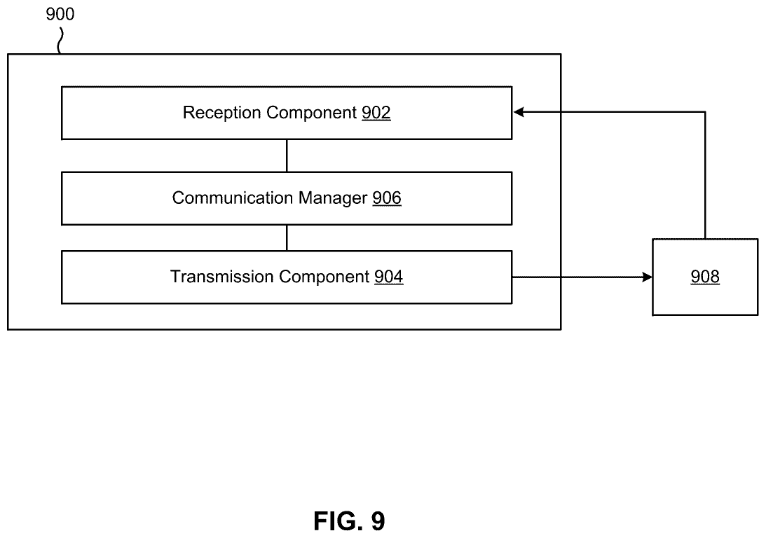

In some aspects, a first UE (e.g., a first UE 120) includes means for receiving one or more configuration messages that indicate one or more parameters that are associated with a single DCI for scheduling multiple UEs for MU-MIMO; and/or means for receiving the single DCI, the single DCI being configured to schedule, as the multiple UEs, the first UE and at least a second UE (e.g., a second UE 120) for the MU-MIMO, the single DCI being based at least in part on the one or more parameters. The means for the first UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG.), and/or a transmission component (for example, transmission component 904 depicted and described in connection with FIG. 9), among other examples.

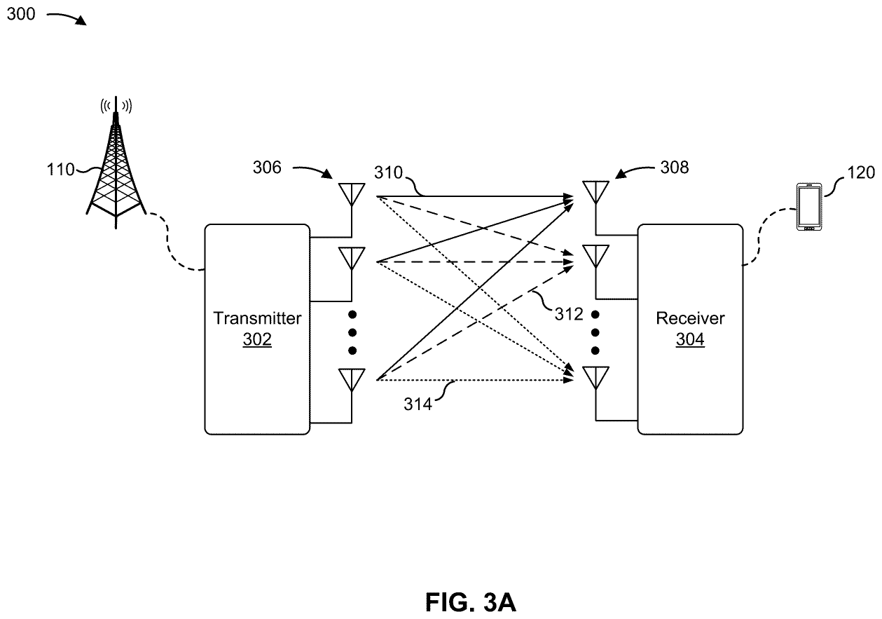

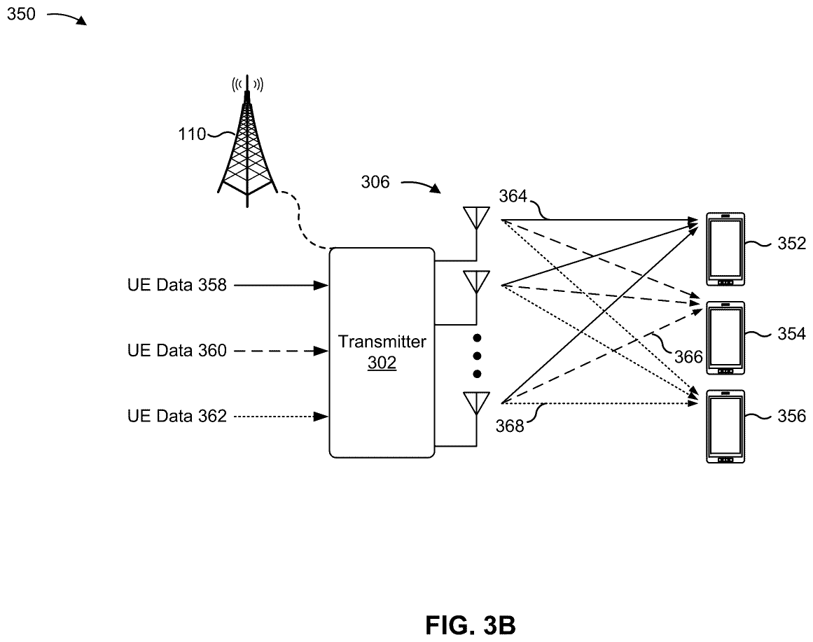

FIGS. 3A and 3B are diagrams illustrating a first example 300 of MIMO and a second example 350 of multiple user (MU)-MIMO, respectively, in accordance with the present disclosure.

The first example 300 shown by FIG. 3A is an example MIMO system that includes a transmitter device 302 (shown by FIG. 3A as being a network node 110) and a receiver device 304 (shown by FIG. 3A as being a UE 120). In the MIMO system, the transmitter device 302 and the receiver device 304 wirelessly communicate with one another based at least in part on multiple antennas. To illustrate, the transmitter device 302 may include M antennas as shown by reference number 306, and the receiver device 304 may include N antennas as shown by reference number 308, where M and N are integers that may be equal or different from one another (e.g., M=N, M>N, and/or M<N).

In some aspects, the transmitter device 302 may transmit multiple data streams via the M antennas based at least in part on using signal diversity, such as spatial diversity and/or polarization diversity. Typically, the number of data streams transmitted by a transmitter device is fewer than a number of antennas. That is, the mapping of the number of data streams to the number of antennas is not 1:1. Rather, each stream may be mapped with a unique set of weights to all of the available antenna such that all of the available antennas are used to transmit the multiple data streams. To illustrate, the transmitter device 302 may transmit a first data stream 310 (shown with a solid line) using all of the M antennas and a first set of precoding weights. Accordingly, each antenna of the M antenna may transmit a respective signal that carries the first data stream, and the respective signal may be precoded using a particular weight in the first set of precoding weights. Alternatively, or additionally, the transmitter device 302 may transmit a second data stream 312 (shown with a dashed line) using all of the M antennas and a second set of precoding weights, and/or a third data stream 314 (shown with a dotted line) using all of the M antennas and a third set of precoding weights. Other examples may include the transmitter device 302 transmitting each data stream using a respective subset of antennas of the M antennas. “Analog beamforming” may denote signal manipulation (e.g., the application of precoding weights) in an analog domain and/or an RF domain, and “digital beamforming” may denote signal manipulation in a digital domain. A transmitter device (e.g., the transmitter device 302) may perform beamforming using analog beamforming, digital beamforming, and/or a combination of analog beamforming and digital beamforming.

“Spatial diversity” may denote spatially diverse signal transmissions. To illustrate, and as described above, the transmitter device 302 may apply precoding to multiple signals that, when summed together, form a first beam at a first carrier frequency, where the first beam propagates in a first direction with a first spatial beamwidth. For example, the precoding may adjust respective phases and/or amplitudes of two or more signals that are transmitted by two or more antennas to constructively form the first beam, and the first beam may carry a first data stream. Alternatively, or additionally, the transmitter device 302 may apply precoding to multiple signals that, when summed together, form a second beam at a second carrier frequency (e.g., that may be the same carrier frequency as the first carrier frequency or a different carrier frequency from the first carrier frequency) that propagates in a second direction with a second spatial beamwidth. In some aspects, the second beam may carry a second data stream that is different from the first data stream. The transmitter device 302 may select the second propagation direction and/or the second spatial beamwidth to mitigate and/or avoid overlap with the first propagation direction and/or the first spatial beamwidth. That is, the first beam and the second beam may be spatially diverse based at least in part on propagating in non-overlapping directions with non-overlapping spatial beamwidths (or partially overlapping directions and/or spatial beamwidths).

“Polarization diversity” may denote at least two signals that have diverse polarizations. As one example, an electromagnetic (EM) wave may include an electric field (E-field) and magnetic field (H-field) that propagate along a same propagation line (e.g., a same direction) and are perpendicular to one another. For example, in an XYZ coordinate system that is characterized by an X-plane, a Y-plane, and a Z-plane that are perpendicular to one another, the E-field of the EM wave is separated from the H-field by 90 degrees. Accordingly, if an E-field that propagates along an X-axis with an amplitude that varies along the Y-axis (e.g., within a horizontal X-Y plane), the H-field may also propagate along the X-axis with an amplitude that varies along the Z-axis (e.g., in a perpendicular, vertical X-Z plane). In linear polarization, the E-field and the H-field may propagate without rotating around the propagation line, while in circular polarization, the E-field and the H-field may rotate around the propagation line. In some aspects, the transmitter device 302 may transmit a first signal that is based at least in part on a first carrier frequency and a first polarization. Alternatively, or additionally, the transmitter device 302 may transmit a second signal that is based at least in part on a second carrier frequency (e.g., that may be the same carrier frequency as the first carrier frequency or a different carrier frequency from the first carrier frequency) and a second polarization that is orthogonal to the first polarization. That is, the first signal and the second signal may have diverse polarizations. For example, the E-field of the first signal is orthogonal to the E-field of the second signal, and the H-field of the first signal is orthogonal to the H-field of the second signal. In some aspects, the first signal may carry first data, and the second signal may carry second data that is different from the first data. To illustrate, the transmitter device 302 may include at least a first antenna that is configured to generate a first signal that has a first polarization and a second antenna that is configured to generate a second signal that has a second polarization.

While the above example describes polarization with respect to orthogonal E-fields and orthogonal H-fields, other examples may use polarizations that are sufficiently decorrelated. For instance, two polarizations may be a complex weighted combination of E-field and H-field polarizations. As another example, the two polarizations may be based at least in part on a polarization distribution of the antenna elements in an antenna array. With enough decorrelation between polarizations, same or different spatial directions (e.g., transmit antenna weights), and same or different frequencies may be used for two transmission paths.

The demand for services provided by a wireless network continues to increase as more and more devices access the wireless network. A MIMO system may, in some cases, meet the demand based at least in part on the ability to simultaneously and/or contemporaneously transmit multiple data streams. To illustrate, and as described above, the use of multiple antennas in a MIMO system allows a transmitter device to simultaneously and/or contemporaneously transmit the multiple data streams using different paths (e.g., different spatial paths and/or different polarization paths), resulting in increased data throughput based at least in part on transmitting multiple data streams using diverse signals.

The second example 350 shown by FIG. 3B is an example of MU-MIMO in which the transmitter device 302 (e.g., the network node 110) simultaneously serves multiple UEs based at least in part on beamforming, spatial diversity (e.g., spatial multiplexing), and/or polarization diversity (e.g., polar multiplexing). For instance, the transmitter device may simultaneously serve a first UE 352, a second UE 354, and a third UE 356 using MU-MIMO communications. To illustrate, the transmitter device 302 may transmit first UE data 358 (shown with a solid line) that is associated with the first UE 504 using a first beam, second UE data 360 (shown with a dashed line) that is associated with the second UE 354 using a second beam, and third UE data 362 (shown with a dotted line) that is associated with the third UE 356 using a third beam. As shown by reference number 364, the transmitter device 302 may form the first beam by applying first precoding to multiple signals (illustrated by FIG. 3B with solid lines) that, when summed together, form the first beam. In a similar manner, as shown by reference number 366, the transmitter device 302 may form the second beam by applying second precoding to multiple signals (illustrated by FIG. 3B with dashed lines), and may form the third beam by applying third precoding to multiple signals (illustrated by FIG. 3B with dotted lines) as shown by reference number 368. The multiple signals that form the first beam, the multiple signals that form the second beam, and the multiple signals that form the third beam may be simultaneously emitted by one or more of the multiple antennas shown by reference number 306. The first beam, the second beam, and the third beam may use different carrier frequencies, may use a same carrier frequency, may use different air interface resources, and/or may use a same air interface resource. The first UE 352, the second UE 354, and the third UE 356 may include, respectively, a single antenna port or multiple antenna ports, and each antenna port may be associated with one or more antennas of the respective UE. The simultaneous transmissions to respective devices (e.g., UEs in the second example 350) may alternatively be referred to as MU-MIMO communications.

A network node may select and/or group UEs for MU-MIMO communications in a same time partition (e.g., a slot) based at least in part on a variety of factors that may affect MU-MIMO performance (e.g., increase or decrease data throughput). For instance, the network node may select UEs based at least in part on UE location and/or beams that are used to communicate with the UEs. To illustrate, the network node may select and/or group UEs that are associated with different beams, beams that have low correlation, and/or beams that have high spatial diversity. As another example, the network node may select and/or group UEs based at least in part on one or more signal quality metrics, such as by grouping UEs that are associated with CQI metrics that satisfy a CQI threshold and/or UEs that are associated with sounding reference signal (SRS) signal-to-interference-plus-noise ratio (SINR) metrics that satisfy an SRS SINR threshold. Alternatively, or additionally, the network node may enable and/or disable MU-MIMO communications based on a variety of factors that affect MU-MIMO performance, such as a number of UEs served by the network node, a traffic load of the network node, a scatter distribution in a cell provided by the network node, and/or a UE distribution (e.g., location distribution) in the cell provided by the network node.

As indicated above, FIGS. 3A and 3B are provided as examples. Other examples may differ from what is described with regard to FIGS. 3A and 3B.

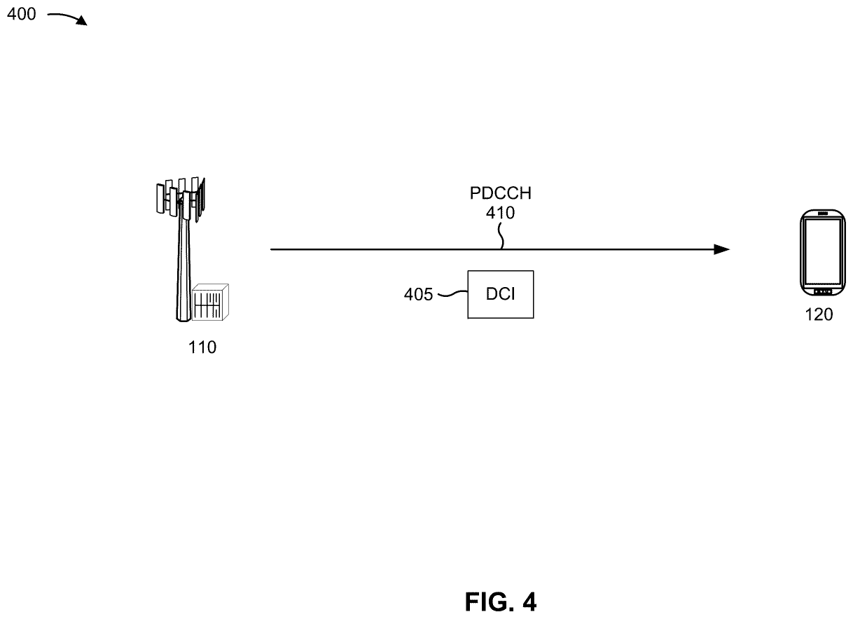

FIG. 4 is a diagram illustrating an example 400 of DCI that schedules one or more communications with a UE, in accordance with the present disclosure. As shown in FIG. 4, a network node 110 may communicate DCI to a UE 120 directly, but other examples may include the network node 110 communicating the DCI to the UE 120 via one or more network nodes.

The network node 110 may transmit, to the UE 120 (e.g., directly or via one or more network nodes), DCI 405 that schedules one or more communications for the UE 120. In some aspects, the network node 110 may transmit the DCI 405 in PDCCH 410 and/or using Layer 1 signaling. “Downlink DCI” may refer to DCI that schedules a downlink communication (e.g., a PDSCH communication and/or a CSI-RS) to the UE 120, and “uplink DCI” may refer to DCI that schedules an uplink communication (e.g., a PUSCH communication or an SRS) from the UE. The DCI 405 may indicate any combination of transmission information, such as a transmission format, an MCS, a resource allocation, and/or other types of information used by a transmitter to encode, and/or receiver to decode, transmitted data.

The DCI 405 may be configured in a variety of DCI formats that partition the DCI 405 into different bitfields that may be of varying length. Each DCI format may be associated with a different transmission direction and/or communication channel. As one example, “DCI Format 0_1” may be associated with a first communication configuration for a PUSCH communication and “DCI Format 0_2” may be associated with a second communication configuration for a PUSCH communication. “DCI Format 1_0” may be associated with a third communication configuration for a PDSCH communication and “DCI Format 1_1” may be associated with a fourth communication configuration for a PDSCH communication. “DCI Format 0_1” and “DCI Format 0_2” may both be referred to as uplink DCI, and DCI Format 1_0″ and “DCI Format 1_1” may both be referred to as downlink DCI.

Each format may partition the DCI 405 differently such that each DCI format includes a different combination of bitfields relative to the other DCI formats. In some aspects, at least two DCI formats (e.g., one or more uplink DCI formats and/or one or more downlink DCI formats) may include a same bitfield (e.g., a same bit length in a same location of the DCI), such as a DCI format indicator field. Alternatively, or additionally, at least two DCI formats may include bitfields that indicate the same transmission information and are positioned at different locations in the DCI and/or have a different bit length. For example, “DCI Format 1_0” and “DCI Format 0_1” may each include a respective MCS bitfield that is positioned at different locations in the DCI. In some aspects, uplink DCI formats (e.g., “DCI Format 0_1” and/or “DCI Format 0_2”) may include one or more bitfields that are associated with uplink transmission information, and downlink DCI formats (e.g., “DCI Format 1_0” and/or “DCI Format 1_1”) may include one or more bitfields that are associated with downlink transmission information.

The PDCCH 410 may be based at least in part on a control resource set (CORESET), a search space, and one or more control channel element (CCE) candidates within the CORESET. For instance, the CORESET may be a set of physical air interface resources (e.g., one or more frequency resources and/or time resources) that the network node 110 uses to transmit control signaling, such as the PDCCH. In some aspects, the air interface resources include one or more physical resource blocks (PRBs) and one or more symbols (e.g., OFDM symbols). A search space may specify where within the CORESET a UE should search for the PDCCH. The search space may be either UE-specific or common to multiple UEs, and may map one or more CCE candidates to resource elements (REs) within the CORESET.

A network node may adjust a number of CCEs and/or a number of CCE candidates that are allocated to a PDCCH, which may alternatively be referred to as a PDCCH aggregation level or simply an aggregation level. For instance, in high signal quality conditions (e.g., low interference and/or high signal power as specified by the network node), the network node may use a low aggregation level to reduce a number of CCEs that are allocated to the PDCCH and conserve the air interface resources for other uses. In low signal quality conditions (e.g., high interference and/or low signal power as specified by the network node), the network node may use a high aggregation level to increase a number of CCEs that are allocated to the PDCCH, to increase a likelihood that a UE may receive and decode control information transmitted via the PDCCH. For instance, the increased number of CCEs may be used by the network node to transmit repetitions of the control information. Accordingly, a number of CCEs included in the PDCCH may be based at least in part on the number of PRBs allocated to the PDCCH, a number of symbols allocated to the PDCCH, and/or an aggregation level. Based at least in part on the CORESET residing in a specific portion of a time-frequency resource grid, and balancing control signaling with data throughput, the number of CCEs may be minimal, reduced, and/or governed by the available resources.

PDCCH MU-MIMO enables a network node to transmit control information via the PDCCH to multiple UEs simultaneously using spatial multiplexing and sharing the air interface resources assigned to the PDCCH. For instance, for each UE scheduled for MU-MIMO communications, the network node may transmit UE-specific control information in the PDCCH using a respective beam that is directed to the respective UE. The use of PDCCH MU-MIMO by a network node may be transparent to a single antenna port UE insofar as the single antenna port UE may not receive the other beams carrying the respective control information for other UEs and/or the network node may use a same DCI signaling mechanism for scheduling the single antenna port UE, whether the DCI signaling mechanism is used in a PDCCH MU-MIMO communication or a single user PDCCH communication (e.g., that is not part of a MU-MIMO communication). PDCCH MU-MIMO may increase a control signaling capacity of a network node, but may be conditioned on each UE scheduled for the PDCCH MU-MIMO being spatially separated with low coherence and use different data beam directions, which may reduce a number of UEs that are available for simultaneous MU-MIMO communications and/or simultaneous PDCCH MU-MIMO that use a same time partition (e.g., a slot) and/or a same frequency partition.

As part of PDCCH MU-MIMO scheduling a network node may send respective control information to each UE, even in a scenario in which the UEs are being scheduled for MU-MIMO data communications. To illustrate, in scheduling three UEs for simultaneous MU-MIMO data communications, the network node may transmit three separate DCI messages. Typically, the network node uses different CCEs for the separate DCI messages, such as by using CCEs 0-7 for first DCI that is transmitted using a first beam, CCEs 8-11 for second DCI that is transmitted using a second beam, and CCEs 12-15 for third DCI that is transmitted using a third beam. Although PDCCH MU-MIMO may be used by a network node to increase a capacity of the PDCCH and/or increase a number of UEs that may be scheduled via the PDCCH, the minimal number of CCEs may result in a PDCCH block issue (e.g., CCEs are unavailable to the network node) during particular operating conditions, such as a high traffic volume operating condition and/or a peak traffic volume operating condition. PDCCH blocking may result in increased transmission delays (e.g., delayed scheduling and/or delayed data transfers) and/or reduced system throughput (e.g., reduced data throughput). PDCCH MU-MIMO may increase the transmission delays and/or may reduce system throughput more because PDCCH block issues may apply to multiple UEs, rather than a single UE.

Various aspects relate generally to single DCI for scheduling multiple UEs for MU-MIMO. Some aspects more specifically relate to the use of a single DCI, rather than respective DCIs, for the multiple UEs to reduce CCE usage in a PDCCH. In some aspects, a network node may transmit one or more configuration messages that indicate one or more parameters that are associated with a single DCI for scheduling multiple UEs with MU-MIMO. For instance, as described below, the network node may transmit the configuration message(s) via RRC signaling, and the configuration messages may indicate one or more configuration parameters associated with a group common PDCCH (GC-PDCCH) that enables the network node to transmit DCI to a group of devices simultaneously. Based at least in part on transmitting the configuration message(s), the network node may transmit the single DCI. In some aspects, the single DCI may be configured to schedule a first UE and at least a second UE for MU-MIMO communications. The single DCI may be based at least in part on the one or more parameters indicated via the configuration messages.

In some aspects, a first UE may receive one or more configuration messages that indicate one or more parameters that are associated with a single DCI that schedules multiple UEs with MU-MIMO. Based at least in part on receiving the one or more configuration messages, the first UE may receive the single DCI (e.g., using the one or more parameters), and the single DCI may be configured to schedule the first UE and at least a second UE with the MU-MIMO.

Particular aspects of the subject matter described in this disclosure can be implemented to realize one or more of the following potential advantages. In some examples, by using a single DCI to schedule multiple UEs with MU-MIMO, the described techniques can be used to enable a network node to reduce a number of CCEs that are used to transmit DCI that schedules the multiple UEs with MU-MIMO. Reducing the number of CCEs used by the network node to schedule MU-MIMO May lead to the MU-MIMO scheduling process being less susceptible to PDCCH blocking, resulting in reduced transmission delays and/or increased system throughput.

As indicated above, FIG. 4 is provided as an example. Other examples may differ from what is described with respect to FIG. 4.

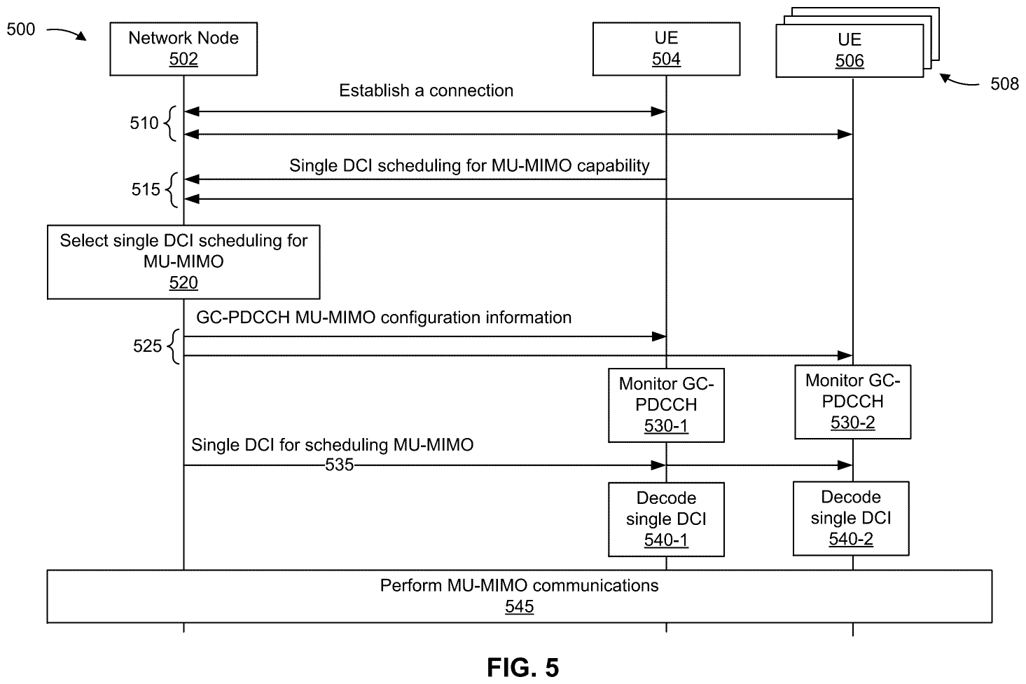

FIG. 5 is a diagram illustrating an example 500 of a wireless communication process between a network node (e.g., the network node 110), a first UE 504 (e.g., a first UE 120), and a second UE 506 (e.g., a second UE 120), in accordance with the present disclosure. As shown by reference number 508, the wireless communication process may include more than two UEs, and each UE may perform similar signaling transactions and/or actions as described with regard to the first UE 504 and/or the second UE 506.

As shown by reference number 510, a network node 502 may establish a first connection with a first UE 504. As also shown by reference number 510, the network node 502 may establish a second connection with the second UE 506. To illustrate, the first UE 504 and/or the second UE 506 may power up in a cell coverage area provided by the network node 502. The first UE 504 and/or the second UE 506 may perform one or more procedures (e.g., a random access channel (RACH) procedure and/or an RRC procedure) with the network node 502 to establish a wireless connection. As another example, the first UE 504 and/or the second UE 506 may move into the cell coverage area provided by the network node 502 and may perform a handover from a respective source network node (e.g., another network node 110) to the network node 502. Alternatively, or additionally, the network node 502 and the first UE 504 and/or the second UE 506 may communicate via the connection based at least in part on any combination of Layer 1 signaling (e.g., DCI and/or uplink control information (UCI)), Layer 2 signaling (e.g., a MAC control element (CE)), and/or Layer 3 signaling (e.g., RRC signaling). To illustrate, the network node 502 may request, via respective RRC signaling to each UE, UE capability information, and/or the first UE 504 and/or the second UE 506 may transmit, via respective RRC signaling to the network node 502, the UE capability information. As part of communicating via the connection, the network node 502 may transmit configuration information via Layer 3 signaling (e.g., respective RRC signaling), and activate and/or deactivate a particular configuration via Layer 2 signaling (e.g., a respective MAC CE) and/or Layer 1 signaling (e.g., respective DCI). To illustrate, the network node 502 may transmit, via respective RRC signaling to each UE, the configuration information via Layer 3 signaling at a first point in time associated with the respective UE being tolerant of communication delays, and the network node 502 may transmit an activation of the configuration via respective Layer 2 signaling and/or respective Layer 1 signaling at a second point in time associated with the respective UE being less tolerant to communication delays.

As shown by reference number 515, the first UE 504 may transmit, and the network node 502 may receive, a first indication of a single DCI scheduling for MU-MIMO capability. As also shown by reference number 515, the second UE 506 may transmit, and the network node 502 may receive, a second indication of a single DCI scheduling for MU-MIMO capability. For clarity, FIG. 5 illustrates the first UE 504 and the second UE 506 transmitting the first indication and the second indication, respectively, of the single DCI scheduling for MU-MIMO capability in separate transactions than establishing the first connection and the second connection, respectively, with the network node 502. However, in some examples, the first UE 504 and/or the second UE 506 may transmit the indication of the single DCI scheduling for MU-MIMO capability as part of establishing the respective connection with the network node 502.

As one example, the first UE 504 and/or the second UE 506 may indicate a capability to support single DCI for scheduling multiple UEs for MU-MIMO. Alternatively, or additionally, the first UE 504 and/or the second UE 506 may indicate a version of single DCI for scheduling multiple UEs for MU-MIMO that the respective UE supports, and in some aspects, each version may be associated with a different DCI format that is used by the single DCI.

As shown by reference number 520, the network node 502 may select single DCI scheduling for MU-MIMO. For instance, the network node 502 may select to use single DCI scheduling for MU-MIMO for the first UE 504 and the second UE 506. That is, the network node 502 may determine whether or not to use single DCI for scheduling the first UE 504 and at least the second UE 506 with MU-MIMO (or to use PDCCH MU-MIMO for scheduling the first UE 504 and the second UE 506 with MU-MIMO). The network node 502 may select to use the single DCI for scheduling the first UE 504 and at least the second UE 506 for MU-MIMO based at least in part on a variety of factors.

As one example, the network node 502 may select to use the single DCI based at least in part on the first UE 504 and at least the second UE 506 indicating support for single DCI that schedules multiple UEs for MU-MIMO as described with regard to reference number 515. Alternatively, or additionally, the network node 502 may select the first UE 504 and at least the second UE 506 for grouping in a single DCI communication based at least in part on the first UE 504 and at least the second UE 506 satisfying a MU-MIMO grouping condition. Some non-limiting examples of a MU-MIMO grouping condition include a spatial separation between the first UE and the second UE satisfying a separation threshold, a respective measurement metric associated with each UE satisfying a metric threshold (e.g., a respective SINR metric), and/or a network load associated with the network node 502 satisfying a load threshold. For example, a separation threshold may specify a UE distance and/or beam separation metric (e.g., linear distance, angular separation, and/or beam divergent) that increases MU-MIMO performance, while a metric threshold may specify a value that qualifies a metric as being satisfactory for MU-MIMO performance (e.g., a power level threshold). A load threshold may indicate a value that qualifies a current load at the network node as being satisfactory and/or increases MU-MIMO performance.

In some aspects, the network node 502 may select to use the single DCI for scheduling the first UE 504 and at least the second UE 506 for MU-MIMO based at least in part on a PDCCH allocation failing based at least in part on a lack of CCEs (e.g., contiguous CCEs) to allocate a PDCCH MU-MIMO communication and/or a number of available CCEs (e.g., contiguous CCEs) failing to satisfy an availability threshold. An availability threshold may specific a number of CCEs (e.g., contiguous CCEs) that are necessary for a successful PDCCH MU-MIMO communication. Alternatively, or additionally, the network node 502 may select to use the single DCI for scheduling the first UE 504 and at least the second UE 506 for MU-MIMO based at least in part on an inter-UE CCE blocking condition being satisfied, where the inter-UE CCE blocking condition may be associated with the network node 502 detecting a presence of inter-UE CCE blocking (e.g., CCEs associated with different UEs overlap or conflict with one another).

As shown by reference number 525, the network node 502 may transmit, and the first UE 504 may receive, a first configuration message that indicates first configuration information. As also shown by reference number 525, the network node 502 may transmit, and the second UE 506 may receive, a second configuration message that indicates second configuration information. In some aspects, the configuration information may be associated with configuring GC-PDCCH MU-MIMO, such as by indicating one or more parameters that indicate, to the first UE 504 and/or the second UE 506, configuration information about the GC-PDCCH (e.g., CORESET information for the GC-PDCCH, a search space for the GC-PDCCH, and/or monitoring occasions). Alternatively, or additionally, the configuration information may indicate, to the first UE 504 and/or the second UE 506, a configuration and/or a format of the single DCI that schedules multiple UEs (e.g., the first UE 504 and at least the second UE 506) for MU-MIMO. Accordingly, “configuring the GC-PDCCH” may denote indicating configuration information about the GC-PDCCH and/or indicating configuration information about information carried by the GC-PDCCH, such as configuration information that indicates a configuration and/or format for the single DCI for scheduling multiple UEs for MU-MIMO. The network node 502 may transmit the configuration information to the first UE 504 and at least the second UE 506 based at least in part on the first UE 504 and at least the second UE 506 satisfying one or more of the MU-MIMO grouping conditions as described above with regard to reference number 520.

To transmit the configuration information, the network node 502 may transmit first signaling (e.g., first RRC signaling) that is directed to the first UE 504 and second signaling (e.g., second RRC signaling). The first signaling and the second signaling may be respective configuration messages that indicate the respective configuration information that is associated with configuring the GC-PDCCH and/or the single DCI for scheduling multiple UEs with MU-MIMO. As one example, the network node 502 may transmit a first RRC reconfiguration message that is directed to the first UE 504 and a second RRC reconfiguration message that is directed to the second UE 506, and each RRC reconfiguration message may include and/or indicate the configuration information. The first RRC reconfiguration message and/or the second RRC reconfiguration message may include a respective information element (IE) that indicates the one or more parameters that are associated with configuring the GC-PDCCH and/or the single DCI.

As described above, the one or more parameters may be GC-PDCCH parameters that are associated with single DCI for scheduling the first UE 504 and at least the second UE 506 for MU-MIMO. To illustrate, a first GC-PDCCH parameter may configure the GC-PDCCH and/or the single DCI for a group common PDSCH allocation that uses a group common radio network temporary identifier (GC-RNTI). Alternatively, or additionally, the first GC-PDCCH parameter may indicate a first UE-specific index that is associated with the group common PDSCH allocation. Alternatively, or additionally, a second GC-PDCCH parameter may configure the GC-PDCCH and/or the single DCI for the group common PDSCH allocation that uses the GC-RNTI (e.g., the same GC-RNTI as indicated in the first GC-PDCCH parameter) and/or may indicate a second UE-specific index. While the first GC-PDCCH parameter and the second GC-PDCCH parameter are associated with configuring the GC-PDCCH for a group common PDSCH allocation that uses a shared GC-RNTI for multiple UEs, other examples may include a GC-PDCCH parameter configuring the GC-PDCCH and/or the single DCI for a group common PUSCH allocation that uses a GC-RNTI. In configuring the GC-PDCCH and/or the single DCI, the network node may indicate the configuration to one or more UEs, such as the first UE 504 and/or the second UE 506.

In some aspects, the GC-PDCCH parameters may include a third GC-PDCCH parameter that configures a common uplink grant field (e.g., common to all UEs associated with a subsequent single DCI) and/or a fourth GC-PDCCH parameter that configures a common downlink grant field (e.g., common to all UEs associated with the subsequent single DCI). Examples of a common grant field may include a time domain resource allocation (TDRA) field and/or frequency domain resource allocation (FDRA) field in the single DCI.

While the GC-PDCCH parameters indicated by the network node 502 may configure the GC-PDCCH and/or the single DCI based at least in part on indicating common parameters that are associated with, and/or common to, all UEs that are associated with a subsequent single DCI and/or are grouped together for MU-MIMO, the GC-PDCCH parameters indicated by the network node 502 may alternatively, or additionally, configure the GC-PDCCH and/or the single DCI for one or more UE-specific parameters and/or one or more UE-specific fields. To illustrate, the GC-PDCCH parameters may configure the GC-PDCCH (and/or the single DCI carried by the GC-PDCCH) for and/or with a UE-specific schedule field, a UE-specific reference signal port differential field (e.g., a DMRS port differential field), a UE-specific HARQ differential field, a UE-specific transmit precoding matrix indicator (TPMI) field (e.g., associated with a PUSCH transmission), and/or a UE-specific spatial separation field (e.g., associated with a PDSCH transmission). The UE-specific fields may be based at least in part on a common uplink allocation (e.g., a common PUSCH allocation) and/or a common downlink allocation (e.g., a common PDSCH allocation) that is common to all UEs associated with MU-MIMO scheduling via the single DCI. To illustrate, the UE-specific schedule field may indicate a schedule differential that is relative to the common uplink allocation and/or the common downlink allocation. Alternatively, or additionally, the UE-specific parameters may indicate if scheduling indicated in the single DCI is for a particular UE (or not).

The network node 502 may configure the GC-PDCCH and/or the single DCI with multiple sets of UE-specific fields, and the UE-specific fields may be partitioned into UE-specific field sub-groupings (e.g., within the single DCI). Each UE-specific field sub-grouping may be associated with a respective UE-specific index. For instance, the first UE 504 may be associated with a first UE-specific index, and a first UE-specific sub-grouping associated with the first UE 504 may be accessible and/or mapped using the first UE-specific index. In a similar manner, the second UE 506 may be associated with a second UE-specific index, and a second UE-specific sub-grouping associated with the second UE 506 may be accessible and/or mapped using the second UE-specific index. The network node 502 may indicate and/or configure each UE with a respective UE-specific index using the GC-PDCCH parameter(s), such as by indicating a UE-specific index assigned to the respective UE in respective RRC signaling.

In some cases, a UE may use the information in the GC-PDCCH (e.g., a UE-specific schedule field, a UE-specific reference signal port differential field, a UE-specific HARQ differential field, a UE-specific TPMI field, a UE-specific spatial separation field, or any combination thereof) for an inter-UE interference cancellation computation. As an example, the first UE 504, the second UE 506, or both, may use the information in the GC-PDCCH to perform respective PDSCH decoding based at least in part on the inter-UE interference cancellation computation, such as by utilizing the spatial separation and UE-specific parameters to identify the transmission characteristics of other scheduled UEs and apply interference suppression techniques (for example, spatial filtering, beamforming, or signal separation algorithms), thereby reducing interference from other UEs during the downlink reception. Similarly, for uplink transmission, a UE may use the information indicated in the GC-PDCCH to perform PUSCH transmission in a manner that mitigates interference to other co-scheduled UEs, such as by adjusting transmission parameters or employing precoding strategies based on the scheduling and spatial separation information.

As shown by reference number 530-1, the first UE 504 may begin monitoring the GC-PDCCH and, as shown by reference number 530-2, the second UE 506 may begin monitoring the GC-PDCCH. In monitoring the GC-PDCCH, the first UE 504 and/or the second UE 506 may monitor for a signal presence in one or more monitoring occasions of the GC-PDCCH and/or as indicated by the network node 502 (e.g., via the GC-PDCCH parameters). That is, the first UE 504 and/or the second UE 506 may monitor the GC-PDCCH by monitoring for a presence of the single DCI that schedules MU-MIMO in a monitoring occasion of the GC-PDCCH. Based at least in part on identifying a signal presence in a monitoring occasion, the first UE 504 and/or the second UE 506 may analyze the signal to derive whether the signal and/or communication is intended for the UE, such as by identifying whether the signal and/or single DCI indicates the GC-RNTI indicated by the network node 502 in the GC-PDCCH parameters. As described below, the first UE 504 and/or the second UE 506 may decode information carried by the signal and/or communication using group common information and/or UE-specific information.

As shown by reference number 535, the network node 502 may transmit, and any combination of the first UE 504 and/or the second UE 506 may receive, single DCI for scheduling MU-MIMO. In some aspects, the network node 502 may transmit the single DCI for scheduling the MU-MIMO in the GC-PDCCH. As one example, the network node 502 may transmit the single DCI in the GC-PDCCH and using a wide beam that is configured for the first UE 504 and the second UE 506. To illustrate, the wide beam may have a spatial width that is based at least in part on a spatial difference between the first UE 504 and/or the second UE 506, and/or results in a beam that reaches both the first UE 504 and the second UE 506. As another example, the network node 502 may transmit the single DCI in the GC-PDCCH using a first beam that is directed to the first UE 504 and a second beam that is directed to the second UE 506. The single DCI may use and/or be located in a same set of CCEs in the first beam and the second beam.

As shown by reference number 540-1, the first UE 504 may decode single DCI. Alternatively, or additionally, as shown by reference number 540-2, the second UE 506 may decode the single DCI. To illustrate, based at least in part on monitoring the GC-PDCCH as described with regard to reference number 530-1 and reference number 530-2, the first UE 504 and/or the second UE 506 may detect a presence of the single DCI in the GC-PDCCH, such as by detecting that a signal power level in one or more CCE candidates associated with the GC-PDCCH that satisfies a power threshold. In detecting a presence of the single DCI, the first UE 504 may derive that the single DCI includes information directed to the first UE 504, and/or the second UE 506 May derive that the single DCI includes information directed to the second UE 506. For instance, the first UE 504 and/or the second UE 506 may identify that the single DCI is addressed to a GC-RNTI that is associated with the first UE 504 and/or the second UE 506. As one example, the single DCI may be scrambled with the GC-RNTI. Alternatively, or additionally, the first UE 504 and/or the second UE 506 may detect information in a respective UE-specific field sub-grouping that is associated with the respective UE.

Based at least in part on identifying a presence of the single DCI and/or detecting that the single DCI includes information that is directed to the respective UE, the first UE 504 and/or the second UE 506 may decode one or more common fields in the DCI that are associated with the single DCI. Alternatively, or additionally, the first UE 504 and/or the second UE 506 may decode one or more UE-specific fields that are included in the single DCI, such as by locating a UE-specific field sub-grouping that is based at least in part on a UE-specific index that is assigned to the respective UE. In some aspects, the first UE 504 and/or the second UE 506 may determine whether the single DCI includes a UE-specific grant that is directed to the respective UE. The first UE 504 and/or the second UE 506 may derive MU-MIMO scheduling information from the single DCI using information decoded from one or more common fields and/or one or more UE-specific fields. For instance, the first UE 504 may derive allocation information using group common allocation information in combination with UE-specific differential allocation information that is specific to the first UE 504 and/or indicated in UE-specific fields of the single DCI that are assigned to the first UE 504. In a similar manner, the second UE 506 may derive allocation information using group common allocation information in combination with UE-specific differential allocation information that is specific to the second UE 506 and/or indicated in UE-specific fields of the single DCI that are assigned to the second UE 506. Accordingly, the single DCI may indicate a respective UE-specific grant to the first UE 504 and/or the second UE 506 using a common grant field and one or more respective UE-specific fields (e.g., in the respective UE-specific field sub-grouping).

As shown by reference number 545, the network node 502, the first UE 504, and at least the second UE 506 may perform MU-MIMO communications, and the MU-MIMO communications may be based at least in part on information indicated in the single DCI. As one example, the MU-MIMO communications may be downlink MU-MIMO communications, and the first UE 504 and/or the second UE 506 may receive and/or decode a respective PDSCH transmission based at least in part on downlink scheduling information derived from the single DCI. In some examples, the first UE 504, the second UE 506, or both, may use information indicated in the GC-PDCCH, such as spatial separation and other UE-specific parameters included in the single DCI to perform interference cancellation. As an example, a UE may use the information to identify the transmission characteristics of other scheduled UEs and apply interference suppression techniques (for example, spatial filtering, beamforming, or signal separation algorithms) to mitigate inter-UE interference during the downlink reception (e.g., PDSCH reception). As another example, the first UE 504 and/or the second UE 506 may transmit a respective PUSCH transmission based at least in part on the scheduling information indicated by the single DCI.

By using a single DCI to schedule multiple UEs with MU-MIMO, a network node may use a reduced a number of CCEs to schedule multiple UEs with MU-MIMO. Reducing the number of CCEs used by the network node to schedule MU-MIMO may lead to the MU-MIMO scheduling process being less susceptible to PDCCH blocking, resulting in reduced transmission delays and/or increased system throughput.

As indicated above, FIG. 5 is provided as an example. Other examples may differ from what is described with regard to FIG. 5.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with single DCI for scheduling multiple UEs for MU-MIMO.

As shown in FIG. 6, in some aspects, process 600 may include transmitting one or more configuration messages that indicate one or more parameters that are associated with a single DCI for scheduling multiple UEs for MU-MIMO (block 610). For example, the network node (e.g., using transmission component 804 and/or communication manager 806, depicted in FIG. 8) may transmit one or more configuration messages that indicate one or more parameters that are associated with a single DCI for scheduling multiple UEs for MU-MIMO, as described above. To illustrate, as described with regard to FIG. 5, the network node may transmit the configuration messages in RRC signaling, such as an RRC reconfiguration message.

As further shown in FIG. 6, in some aspects, process 600 may include transmitting the single DCI, the single DCI being configured to schedule, as the multiple UEs, a first UE and at least a second UE for the MU-MIMO, the single DCI being based at least in part on the one or more parameters (block 620). For example, the network node (e.g., using transmission component 804 and/or communication manager 806, depicted in FIG. 8) may transmit the single DCI, the single DCI being configured to schedule, as the multiple UEs, a first UE and at least a second UE for the MU-MIMO, the single DCI being based at least in part on the one or more parameters, as described above. To illustrate, as described with regard to FIG. 5, the network node may transmit the single DCI in a GC-PDCCH.

Process 600 may include additional aspects, such as any single aspect or any combination of aspects described below and/or in connection with one or more other processes described elsewhere herein.

In a first aspect, process 600 includes receiving first capability information that indicates that the first UE supports the single DCI for scheduling the multiple UEs for the MU-MIMO, and receiving second capability information that indicates that at least the second UE supports the single DCI for scheduling the multiple UEs for the MU-MIMO.

In a second aspect, process 600 includes selecting the first UE and at least the second UE for grouping in the single DCI based at least in part on at least one of a PDCCH allocation failing based at least in part on a lack of CCEs to satisfy an availability threshold, an inter-UE CCE blocking condition being satisfied, or the first UE and at least the second UE satisfying a MU-MIMO grouping condition.

In a third aspect, the MU-MIMO grouping condition is based at least in part on at least one of a spatial separation between the first UE and the second UE satisfying a separation threshold, a measurement metric satisfying a metric threshold, or a network load satisfying a load threshold.

In a fourth aspect, the measurement metric includes a signal-to-interference-plus-noise ratio metric.

In a fifth aspect, transmitting the one or more configuration messages includes transmitting the one or more configuration messages in RRC signaling.

In a sixth aspect, the RRC signaling includes an RRC reconfiguration message.

In a seventh aspect, the one or more parameters indicate one or more GC-PDCCH parameters that are associated with the single DCI.

In an eighth aspect, the one or more GC-PDCCH parameters include at least one of a first GC-PDCCH parameter that configures a group common downlink physical downlink control channel that uses a GC-RNTI and a first UE-specific index, or a second GC-PDCCH parameter that configures a group common downlink physical control channel that uses the GC-RNTI indicated in the first GC-PDCCH parameter and a second UE-specific index.

In a ninth aspect, the one or more GC-PDCCH parameters include at least one of a third GC-PDCCH parameter that configures a common uplink grant, or a fourth GC-PDCCH parameter that configures a common downlink grant.

In a tenth aspect, the one or more GC-PDCCH parameters include one or more UE-specific fields in the GC-PDCCH, the one or more UE-specific fields including at least one of a UE-specific schedule field, a UE-specific reference signal port differential field, a UE-specific hybrid automatic request differential field, a UE-specific transmit precoding matrix field, or a UE-specific spatial separation field.

In an eleventh aspect, the one or more UE-specific fields are partitioned into one or more UE-specific field subgroupings, and each UE-specific field subgrouping is associated with a respective UE-specific index.

In a twelfth aspect, each respective UE-specific index is indicated by the network node in the one or more GC-PDCCH parameters.

In a thirteenth aspect, transmitting the single DCI includes transmitting the single DCI in a GC-PDCCH and using a wide beam that is configured for the first UE and the second UE.

In a fourteenth aspect, transmitting the single DCI includes transmitting the single DCI in a GC-PDCCH using a first beam directed to the first UE, a second beam that is directed to the second UE, and based at least in part on using a same set of control channel elements.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with single DCI for scheduling multiple UEs for MU-MIMO.

As shown in FIG. 7, in some aspects, process 700 may include receiving one or more configuration messages that indicate one or more parameters that are associated with a single DCI for scheduling multiple UEs for MU-MIMO (block 710). For example, the UE (e.g., using reception component 902 and/or communication manager 906, depicted in FIG. 9) may receive one or more configuration messages that indicate one or more parameters that are associated with a single DCI for scheduling multiple UEs for MU-MIMO, as described above. To illustrate, as described above with regard to FIG. 5, the UE may receive a configuration message in RRC signaling, such as by receiving an RRC reconfiguration message.

As further shown in FIG. 7, in some aspects, process 700 may include receiving the single DCI, the single DCI being configured to schedule, as the multiple UEs, the first UE and at least a second UE for the MU-MIMO, the single DCI being based at least in part on the one or more parameters (block 720). For example, the UE (e.g., using reception component 902 and/or communication manager 906, depicted in FIG. 9) may receive the single DCI, the single DCI being configured to schedule, as the multiple UEs, the first UE and at least a second UE for the MU-MIMO, the single DCI being based at least in part on the one or more parameters, as described above. To illustrate, the UE may receive the single DCI in GC-PDCCH as described above with regard to FIG. 5.

Process 700 may include additional aspects, such as any single aspect or any combination of aspects described below and/or in connection with one or more other processes described elsewhere herein.

In a first aspect, process 700 includes transmitting capability information that indicates that the first UE supports the single DCI for scheduling the multiple UEs for the MU-MIMO.

In a second aspect, receiving the one or more configuration messages includes receiving the one or more configuration messages in RRC signaling.

In a third aspect, the RRC signaling includes an RRC reconfiguration message.

In a fourth aspect, the one or more parameters indicate one or more GC-PDCCH parameters that are associated with the single DCI.

In a fifth aspect, process 700 includes performing inter-UE interference cancellation based at least in part on information in the one or more GC-PDCCH parameters.

In a sixth aspect, performing the inter-UE interference cancellation is based at least in part on at least one of: PDSCH reception, or PUSCH transmission.

In a seventh aspect, the one or more GC-PDCCH parameters include at least one of a first GC-PDCCH parameter that configures a group common downlink physical downlink control channel that uses a GC-RNTI and a first UE-specific index, or a second GC-PDCCH parameter that configures a group common downlink physical control channel that uses the GC-RNTI indicated in the first GC-PDCCH parameter and a second UE-specific index.

In an eighth aspect, the one or more GC-PDCCH parameters include at least one of a third GC-PDCCH parameter that configures a common uplink grant, or a fourth GC-PDCCH parameter that configures a common downlink grant.

In a ninth aspect, the one or more GC-PDCCH parameters include one or more UE-specific fields in the GC-PDCCH, the one or more UE-specific fields including at least one of a UE-specific schedule field, a UE-specific reference signal port differential field, a UE-specific hybrid automatic request differential field, a UE-specific transmit precoding matrix field, or a UE-specific spatial separation field.

In a tenth aspect, the one or more UE-specific fields are partitioned into one or more UE-specific field subgroupings, and each UE-specific field subgrouping is associated with a respective UE-specific index.

In an eleventh aspect, each respective UE-specific index is indicated in the one or more GC-PDCCH parameters.

In a twelfth aspect, process 700 includes monitoring a GC-PDCCH for the single DCI, and receiving the single DCI includes receiving the single DCI in the GC-PDCCH.

In a thirteenth aspect, process 700 includes detecting the single DCI in the GC-PDCCH, deriving that the single DCI includes information directed to the first UE, decoding, based at least in part on the single DCI including the information that is directed to the first UE, one or more common fields in the DCI that are associated with the single DCI scheduling the first UE and at least the second UE for the MU-MIMO, and decoding, based at least in part on the single DCI including the information that is directed to the first UE, one or more UE-specific fields that are included in the single DCI.

In a fourteenth aspect, process 700 includes determining whether the single DCI includes a UE-specific grant that is directed to the first UE based at least in part on at least one of: the single DCI being addressed to a GC-RNTI that is associated with the first UE, or a UE-specific field in the single DCI that is associated with the first UE.

In a fifteenth aspect, the single DCI includes the UE-specific grant that is directed to the first UE, and the UE-specific grant is based at least in part on: a common grant field UE and the UE-specific field.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIG. 4-5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit one or more configuration messages that indicate one or more parameters that are associated with a single DCI for scheduling multiple UEs for MU-MIMO. The transmission component 804 may transmit the single DCI, the single DCI being configured to schedule, as the multiple UEs, a first UE and at least a second UE for the MU-MIMO, the single DCI being based at least in part on the one or more parameters.

The reception component 802 may receive first capability information that indicates that the first UE supports the single DCI for scheduling the multiple UEs for the MU-MIMO. Alternatively, or additionally, the reception component 802 may receive second capability information that indicates that at least the second UE supports the single DCI for scheduling the multiple UEs for the MU-MIMO.

The communication manager 806 may select the first UE and at least the second UE for grouping in the single DCI based at least in part on at least one of a PDCCH allocation failing based at least in part on a lack of CCEs to satisfy an availability threshold, an inter-UE CCE blocking condition being satisfied, or the first UE and at least the second UE satisfying a MU-MIMO grouping condition.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIG. 4-5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive one or more configuration messages that indicate one or more parameters that are associated with a single DCI for scheduling multiple UEs for MU-MIMO. The reception component 902 may receive the single DCI, the single DCI being configured to schedule, as the multiple UEs, the first UE and at least a second UE for the MU-MIMO, the single DCI being based at least in part on the one or more parameters.

The transmission component 904 may transmit capability information that indicates that the first UE supports the single DCI for scheduling the multiple UEs for the MU-MIMO. In some aspects, the communication manager 906 may monitor a GC-PDCCH for the single DCI. Alternatively, or additionally, the communication manager 906 may detect the single DCI in the GC-PDCCH. The communication manager 906 may derive that the single DCI includes information directed to the first UE. In some aspects, the communication manager 906 may decode, based at least in part on the single DCI including the information that is directed to the first UE, one or more common fields in the DCI that are associated with the single DCI scheduling the first UE and at least the second UE for the MU-MIMO. Alternatively, or additionally, the communication manager 906 may decode, based at least in part on the single DCI including the information that is directed to the first UE, one or more UE-specific fields that are included in the single DCI.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a network node, comprising: transmitting one or more configuration messages that indicate one or more parameters that are associated with a single downlink control information (DCI) for scheduling multiple user equipments (UEs) for multiple-user multiple-input-multiple-output (MU-MIMO); and transmitting the single DCI, the single DCI being configured to schedule, as the multiple UEs, a first UE and at least a second UE for the MU-MIMO, the single DCI being based at least in part on the one or more parameters.
Aspect 2: The method of Aspect 1, further comprising: receiving first capability information that indicates that the first UE supports the single DCI for scheduling the multiple UEs for the MU-MIMO; and receiving second capability information that indicates that at least the second UE supports the single DCI for scheduling the multiple UEs for the MU-MIMO.
Aspect 3: The method of any of Aspects 1-2, further comprising: selecting the first UE and at least the second UE for grouping in the single DCI based at least in part on at least one of: a PDCCH allocation failing based at least in part on a lack of control channel elements (CCEs) to satisfy an availability threshold, an inter-UE CCE blocking condition being satisfied, or the first UE and at least the second UE satisfying a MU-MIMO grouping condition.
Aspect 4: The method of Aspect 3, wherein the MU-MIMO grouping condition is based at least in part on at least one of: a spatial separation between the first UE and the second UE satisfying a separation threshold, a measurement metric satisfying a metric threshold, or a network load satisfying a load threshold.
Aspect 5: The method of Aspect 4, wherein the measurement metric comprises a signal-to-interference-plus-noise ratio metric.
Aspect 6: The method of any of Aspects 1-5, wherein transmitting the one or more configuration messages comprises: transmitting the one or more configuration messages in radio resource control (RRC) signaling.
Aspect 7: The method of Aspect 6, wherein the RRC signaling comprises an RRC reconfiguration message.
Aspect 8: The method of any of Aspects 1-7, wherein the one or more parameters indicate one or more group common physical downlink control channel (GC-PDCCH) parameters that are associated with the single DCI.
Aspect 9: The method of Aspect 8, wherein the one or more GC-PDCCH parameters comprise at least one of: a first GC-PDCCH parameter that configures a group common downlink physical downlink control channel that uses a group common radio network temporary identifier (GC-RNTI) and a first UE-specific index, or a second GC-PDCCH parameter that configures a group common downlink physical control channel that uses the GC-RNTI indicated in the first GC-PDCCH parameter and a second UE-specific index.
Aspect 10: The method of Aspect 8 or Aspect 9, wherein the one or more GC-PDCCH parameters comprise at least one of: a third GC-PDCCH parameter that configures a common uplink grant, or a fourth GC-PDCCH parameter that configures a common downlink grant.
Aspect 11: The method of any one of Aspects 8-10, wherein the one or more GC-PDCCH parameters comprise one or more UE-specific fields in the GC-PDCCH, the one or more UE-specific fields comprising at least one of: a UE-specific schedule field, a UE-specific reference signal port differential field, a UE-specific hybrid automatic request differential field, a UE-specific transmit precoding matrix field, or a UE-specific spatial separation field.
Aspect 12: The method of Aspect 11, wherein the one or more UE-specific fields are partitioned into one or more UE-specific field subgroupings, and each UE-specific field subgrouping is associated with a respective UE-specific index.
Aspect 13: The method of Aspect 12, wherein each respective UE-specific index is indicated by the network node in the one or more GC-PDCCH parameters.
Aspect 14: The method of any of Aspects 1-13, wherein transmitting the single DCI further comprises: transmitting the single DCI in a GC-PDCCH and using a wide beam that is configured for the first UE and the second UE.
Aspect 15: The method of any of Aspects 1-14, wherein transmitting the single DCI further comprises: transmitting the single DCI in a GC-PDCCH using a first beam directed to the first UE, a second beam that is directed to the second UE, and based at least in part on using a same set of control channel elements.
Aspect 16: A method of wireless communication performed by a first user equipment (UE), comprising: receiving one or more configuration messages that indicate one or more parameters that are associated with a single downlink control information (DCI) for scheduling multiple UEs for multiple-user multiple-input-multiple-output (MU-MIMO); and receiving the single DCI, the single DCI being configured to schedule, as the multiple UEs, the first UE and at least a second UE for the MU-MIMO, the single DCI being based at least in part on the one or more parameters.
Aspect 17: The method of Aspect 16, further comprising: transmitting capability information that indicates that the first UE supports the single DCI for scheduling the multiple UEs for the MU-MIMO.
Aspect 18: The method of any of Aspects 16-17, wherein receiving the one or more configuration messages comprises: receiving the one or more configuration messages in radio resource control (RRC) signaling.
Aspect 19: The method of Aspect 18, wherein the RRC signaling comprises an RRC reconfiguration message.
Aspect 20: The method of any of Aspects 16-19, wherein the one or more parameters indicate one or more group common physical downlink control channel (GC-PDCCH) parameters that are associated with the single DCI.
Aspect 21: The method of Aspect 20, further comprising: performing inter-UE interference cancellation based at least in part on information in the one or more GC-PDCCH parameters.
Aspect 22: The method of Aspect 20 or Aspect 21, wherein performing the inter-UE interference cancellation is based at least in part on at least one of: physical downlink shared channel reception, or physical uplink shared channel transmission.
Aspect 23: The method of any one of Aspects 20-22, wherein the one or more GC-PDCCH parameters comprise at least one of: a first GC-PDCCH parameter that configures a group common downlink physical downlink control channel that uses a group common radio network temporary identifier (GC-RNTI) and a first UE-specific index, or a second GC-PDCCH parameter that configures a group common downlink physical control channel that uses the GC-RNTI indicated in the first GC-PDCCH parameter and a second UE-specific index.
Aspect 24: The method of any one of Aspects 20-23, wherein the one or more GC-PDCCH parameters comprise at least one of: a third GC-PDCCH parameter that configures a common uplink grant, or a fourth GC-PDCCH parameter that configures a common downlink grant.
Aspect 25: The method of any one of Aspects 20-24, wherein the one or more GC-PDCCH parameters comprise one or more UE-specific fields in the GC-PDCCH, the one or more UE-specific fields comprising at least one of: a UE-specific schedule field, a UE-specific reference signal port differential field, a UE-specific hybrid automatic request differential field, a UE-specific transmit precoding matrix field, or a UE-specific spatial separation field.
Aspect 26: The method of Aspect 25, wherein the one or more UE-specific fields are partitioned into one or more UE-specific field subgroupings, and each UE-specific field subgrouping is associated with a respective UE-specific index.
Aspect 27: The method of Aspect 26, wherein each respective UE-specific index is indicated in the one or more GC-PDCCH parameters.
Aspect 28: The method of Aspect 26 or Aspect 27, further comprising: determining whether the single DCI includes a UE-specific grant that is directed to the first UE based at least in part on at least one of: the single DCI being addressed to a group common radio network temporary identifier (GC-RNTI) that is associated with the first UE, or a UE-specific field in the single DCI that is associated with the first UE.
Aspect 29: The method of any one of Aspects 26-28, wherein the single DCI includes the UE-specific grant that is directed to the first UE, and the UE-specific grant is based at least in part on: a common grant field and the UE-specific field.
Aspect 30: The method of any of Aspects 16-29, further comprising: monitoring a group common physical downlink control channel (GC-PDCCH) for the single DCI, wherein receiving the single DCI comprises: receiving the single DCI in the GC-PDCCH, wherein receiving the single DCI comprises: receiving the single DCI in the GC-PDCCH.
Aspect 31: The method of Aspect 30, further comprising: detecting the single DCI in the GC-PDCCH; deriving that the single DCI includes information directed to the first UE; decoding, based at least in part on the single DCI including the information that is directed to the first UE, one or more common fields in the DCI that are associated with the single DCI scheduling the first UE and at least the second UE for the MU-MIMO; and decoding, based at least in part on the single DCI including the information that is directed to the first UE, one or more UE-specific fields that are included in the single DCI.
Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.
Aspect 33: An apparatus for wireless communication at a device, the apparatus comprising one or more memories and one or more processors coupled to the one or more memories, the one or more processors configured to cause the device to perform the method of one or more of Aspects 1-15.
Aspect 34: An apparatus for wireless communication, the apparatus comprising at least one means for performing the method of one or more of Aspects 1-15.
Aspect 35: A non-transitory computer-readable medium storing code for wireless communication, the code comprising instructions executable by one or more processors to perform the method of one or more of Aspects 1-15.
Aspect 36: A non-transitory computer-readable medium storing a set of instructions for wireless communication, the set of instructions comprising one or more instructions that, when executed by one or more processors of a device, cause the device to perform the method of one or more of Aspects 1-15.
Aspect 37: A device for wireless communication, the device comprising a processing system that includes one or more processors and one or more memories coupled with the one or more processors, the processing system configured to cause the device to perform the method of one or more of Aspects 1-15.
Aspect 38: An apparatus for wireless communication at a device, the apparatus comprising one or more memories and one or more processors coupled to the one or more memories, the one or more processors individually or collectively configured to cause the device to perform the method of one or more of Aspects 1-15.
Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 16-31.
Aspect 40: An apparatus for wireless communication at a device, the apparatus comprising one or more memories and one or more processors coupled to the one or more memories, the one or more processors configured to cause the device to perform the method of one or more of Aspects 16-31.
Aspect 41: An apparatus for wireless communication, the apparatus comprising at least one means for performing the method of one or more of Aspects 16-31.
Aspect 42: A non-transitory computer-readable medium storing code for wireless communication, the code comprising instructions executable by one or more processors to perform the method of one or more of Aspects 16-31.
Aspect 43: A non-transitory computer-readable medium storing a set of instructions for wireless communication, the set of instructions comprising one or more instructions that, when executed by one or more processors of a device, cause the device to perform the method of one or more of Aspects 16-31.
Aspect 44: A device for wireless communication, the device comprising a processing system that includes one or more processors and one or more memories coupled with the one or more processors, the processing system configured to cause the device to perform the method of one or more of Aspects 16-31.
Aspect 45: An apparatus for wireless communication at a device, the apparatus comprising one or more memories and one or more processors coupled to the one or more memories, the one or more processors individually or collectively configured to cause the device to perform the method of one or more of Aspects 16-31.
Aspect 44: A method, device, apparatus, computer program product, non-transitory computer-readable medium, user equipment, base station, network node, wireless communication device, and/or processing system as substantially described herein with reference to and as illustrated by accompanying drawings and specification.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication by a network node, comprising:
a processing system that includes one or more processors and one or more memories, the processing system configured to cause the network node to:
transmit one or more configuration messages that indicate one or more parameters that are associated with a single downlink control information (DCI) for scheduling multiple user equipments (UEs) for multiple-user multiple-input-multiple-output (MU-MIMO); and
transmit the single DCI, the single DCI being configured to schedule, as the multiple UEs, a first UE and at least a second UE for the MU-MIMO, the single DCI being based at least in part on the one or more parameters.

2. The apparatus of claim 1, wherein the processing system is configured to cause the network node to:
receive first capability information that indicates that the first UE supports the single DCI for scheduling the multiple UEs for the MU-MIMO; and
receive second capability information that indicates that at least the second UE supports the single DCI for scheduling the multiple UEs for the MU-MIMO.

3. The apparatus of claim 1, wherein the processing system is configured to cause the network node to:
select the first UE and at least the second UE for grouping in the single DCI based at least in part on at least one of:
a PDCCH allocation failing based at least in part on a lack of control channel elements (CCEs) to satisfy an availability threshold,
an inter-UE CCE blocking condition being satisfied, or
the first UE and at least the second UE satisfying a MU-MIMO grouping condition.

4. The apparatus of claim 1, wherein the processing system, to cause the network node to transmit the one or more configuration messages, is configured to cause the network node to:
transmit the one or more configuration messages in radio resource control (RRC) signaling.

5. The apparatus of claim 1, wherein the one or more parameters indicate one or more group common physical downlink control channel (GC-PDCCH) parameters that are associated with the single DCI.

6. The apparatus of claim 5, wherein the one or more GC-PDCCH parameters comprise one or more UE-specific fields in the GC-PDCCH, the one or more UE-specific fields comprising at least one of:
a UE-specific schedule field,
a UE-specific reference signal port differential field,
a UE-specific hybrid automatic request differential field,
a UE-specific transmit precoding matrix field, or
a UE-specific spatial separation field.

7. The apparatus of claim 1, wherein the processing system, to cause the network node to transmit the single DCI, is configured to cause the network node to:
transmit the single DCI in a GC-PDCCH and using a wide beam that is configured for the first UE and the second UE.

8. The apparatus of claim 1, wherein the processing system, to cause the network node to transmit the single DCI, is configured to cause the network node to:
transmit the single DCI in a GC-PDCCH using a first beam directed to the first UE, a second beam that is directed to the second UE, and based at least in part on using a same set of control channel elements.

9. An apparatus for wireless communication at a first user equipment (UE), comprising:
a processing system that includes one or more processors and one or more memories, the processing system configured to cause the first UE to:
receive one or more configuration messages that indicate one or more parameters that are associated with a single downlink control information (DCI) for scheduling multiple UEs for multiple-user multiple-input-multiple-output (MU-MIMO); and
receive the single DCI, the single DCI being configured to schedule, as the multiple UEs, the first UE and at least a second UE for the MU-MIMO, the single DCI being based at least in part on the one or more parameters.

10. The apparatus of claim 9, wherein the processing system is configured to cause the first UE to:
transmit capability information that indicates that the first UE supports the single DCI for scheduling the multiple UEs for the MU-MIMO.

11. The apparatus of claim 9, wherein the processing system, to cause the first UE to receive the one or more configuration messages, is configured to cause the first UE to:
receive the one or more configuration messages in radio resource control (RRC) signaling.

12. The apparatus of claim 9, wherein the one or more parameters indicate one or more group common physical downlink control channel (GC-PDCCH) parameters that are associated with the single DCI.

13. The apparatus of claim 12, wherein the processing system is configured to cause the first UE to:
perform inter-UE interference cancellation based at least in part on information in the one or more GC-PDCCH parameters.

14. The apparatus of claim 13, wherein performing the inter-UE interference cancellation is based at least in part on at least one of:
physical downlink shared channel reception, or
physical uplink shared channel transmission.

15. The apparatus of claim 12, wherein the one or more GC-PDCCH parameters comprise at least one of:
a first GC-PDCCH parameter that configures a group common downlink physical downlink control channel that uses a group common radio network temporary identifier (GC-RNTI) and a first UE-specific index, or
a second GC-PDCCH parameter that configures a group common downlink physical control channel that uses the GC-RNTI indicated in the first GC-PDCCH parameter and a second UE-specific index.

16. The apparatus of claim 12, wherein the one or more GC-PDCCH parameters comprise at least one of:
a third GC-PDCCH parameter that configures a common uplink grant, or
a fourth GC-PDCCH parameter that configures a common downlink grant.

17. The apparatus of claim 12, wherein the one or more GC-PDCCH parameters comprise one or more UE-specific fields in the GC-PDCCH, the one or more UE-specific fields comprising at least one of:
a UE-specific schedule field,
a UE-specific reference signal port differential field,
a UE-specific hybrid automatic request differential field,
a UE-specific transmit precoding matrix field, or
a UE-specific spatial separation field.

18. The apparatus of claim 9, wherein the processing system is configured to cause the UE to:
monitor a group common physical downlink control channel (GC-PDCCH) for the single DCI,
wherein the processing system, to cause the UE to receive the single DCI, is configured to cause the UE to:
receive the single DCI in the GC-PDCCH.

19. The apparatus of claim 18, wherein the processing system is configured to cause the UE to:
detect the single DCI in the GC-PDCCH;
derive that the single DCI includes information directed to the first UE;
decode, based at least in part on the single DCI including the information that is directed to the first UE, one or more common fields in the DCI that are associated with the single DCI scheduling the first UE and at least the second UE for the MU-MIMO; and
decode, based at least in part on the single DCI including the information that is directed to the first UE, one or more UE-specific fields that are included in the single DCI.

20. A method of wireless communication performed by a first user equipment (UE), comprising:
receiving one or more configuration messages that indicate one or more parameters that are associated with a single downlink control information (DCI) for scheduling multiple UEs for multiple-user multiple-input-multiple-output (MU-MIMO); and
receiving the single DCI, the single DCI being configured to schedule, as the multiple UEs, the first UE and at least a second UE for the MU-MIMO, the single DCI being based at least in part on the one or more parameters.
